(19) United States
(12) Patent Application Publication
(10) Pub. No.: US 2014/0310153 A1
(43) Pub. Date: Oct. 16, 2014

(54) SYSTEMS AND METHODS FOR MOBILE DEVICE FINANCING

(71) Applicant: EBAY INC., San Jose, CA (US)

(72) Inventor: Amol Bhasker Patel, Sunnyvale, CA (US)

(73) Assignee: EBAY INC., San Jose, CA (US)

(21) Appl. No.: 14/195,641

(22) Filed: Mar. 3, 2014

Related U.S. Application Data
(60) Provisional application No. 61/811,646, filed on Apr. 12, 2013.

(51) Int. Cl. G06Q 40/02; G06Q 20/10

(52) U.S. Cl. CPC G06Q 40/025; G06Q 20/102
USPC 705/38

(57) ABSTRACT

A system or method is provided to allow a payment service provider to implement financing for a purchase of a mobile device by an end user or consumer. In particular, a payment service provider may leverage financial transactions processed through the payment service provider to make a more informed determination or decision related to providing financing to customers. For example, the payment service provider may obtain information about the user through the user's payment account, which includes the user's payment history, purchase history, transaction history, credit history, credit store, cash flow, funding accounts, account balances, and any other information related to the user's financial stability or credit worthiness. The information about the user may be used to determine financing terms for the purchase of a mobile device.

### CROSS REFERENCE TO RELATED APPLICATION

Pursuant to 35 U.S.C. §119(e), this application claims priority to the filing date of U.S. Provisional Patent Application No. 61/811,646, filed on Apr. 12, 2013, which is incorporated by reference in its entirety.

### BACKGROUND

1. Field of the Invention

The invention is related generally to systems and methods for implementing mobile device financing.

2. Related Art

Mobile devices continue to increase in popularity, due to the convenience and functionality provided with such devices. However, acquiring a mobile device for use may be costly, as it typically includes a purchase of not just the mobile device (e.g., a smart phone), but also of a service or carrier plan for the device. Mobile communication service providers typically subsidize the cost of mobile devices to entice more customers to subscribe to their mobile communication service. In particular, the mobile communication service providers usually offer a customer with financing for the purchase of a mobile device along with a mobile service plan, such that the cost of the mobile device is paid off in monthly installments to make the cost of the mobile device more affordable to the customer. Nevertheless, the mobile communication service providers, as telecommunication service providers, may not want or be equipped to implement and manage such liability.

### BRIEF DESCRIPTION OF THE FIGURES

FIG. 1 is a block diagram of a networked system suitable for implementing mobile device financing according to an embodiment.

FIG. 2 is a flowchart illustrating a method for implementing financing for a purchase of a mobile device according to an embodiment.

FIG. 3 is a flowchart illustrating a method for implementing repayment and promotion for a mobile device financing according to an embodiment.

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

In one embodiment, a system and method is provided to allow a payment service provider, such as PayPal, Inc. of San Jose, Calif., to implement financing for a purchase of a mobile device by an end user or consumer. In particular, a payment service provider may leverage information obtained from financial transactions processed through the payment service provider to make a more informed determination or decision related to providing financing to customers. For example, the payment service provider may obtain information about the user through the user's payment account, which includes the user's payment history, purchase history, transaction history, credit history, credit store, cash flow, funding accounts, account balances, and any other information related to the user's financial stability or credit worthiness. Payment service also may have access to certain user identifying information, such a name, address, phone number, social security number, credit card number, bank account number, date of birth, etc., alone or in some combination.

In one embodiment, the payment service provider may offer such financing, such as through the payment service provider's web site, app, or other means. The offer may be for new users, i.e., users who never had an account with the payment provider, or users who have an expired account with the payment provider. In another embodiment, the offer may be for current account holders as well. If a user wishes to accept the offer, the payment provider may determine the type of financing to provide to the user. The determination may be based on user history, as noted above, whether the user is a present account holder of the payment provider, a prior account holder of the payment provider, or not a current or prior account holder, the purchase amount of the mobile device, any incentives provided to the payment provider by a mobile carrier providing service for the mobile device or a manufacturer/seller of the mobile device, and/or any risk/credit factors associated with the user, such as, but not limited to location, age, payment history, etc.

For example, if a mobile device OEM provides a discount on the price, the financing may have more favorable terms, such as lower interest rate, longer grace periods, higher financing amount, etc. In another example, the mobile carrier may offer a discount to the user if the user finances the mobile device purchase through the payment provider and/or uses the payment provider to pay for the mobile carrier services. In such a case, the payment provider may again provide more favorable financing because the payment service provider may be able to acquire a new customer through this transaction.

Once financing terms are determined for the user, the user may be required to open an account with the payment service provider (if none already exists). Opening the account may require certain information, such as name, phone number, address, date of birth, email address, one or more funding instruments, such as a bank account, a checking account, a credit card number, and the like. One or more of this information may already be available or previously provided to the payment service provider. In one embodiment, the mobile device OEM, mobile carrier, and/or merchant selling the mobile phone to the customer provides needed information to the payment service provider. Thus, only still needed information may be requested from the user to open an account. The user may also be asked to create a password or PIN for the account, along with a user name if appropriate. Alternatively, the user account may be identified through an email address or mobile phone number.

Once opened, the payment service provider may be able to manage repayment of the loan or financing through the user's payment service provider account. For example, automatic withdrawals from one or more user-selected funding sources may be made at specific times, which may be determined by the payment service provider or the user consistent with the agreed-up terms of the financing.

The payment service provider may also engage with the mobile carrier and/or OEM or mobile device seller for loan repayment as needed. For example, if a user is late or delinquent on a payment, the mobile carrier may notify the user that unless a payment is made current, the mobile communication services may be interrupted. Alternatively, the mobile carrier and/or seller may simply notify the user that he or she is late on a payment to the payment service provider.

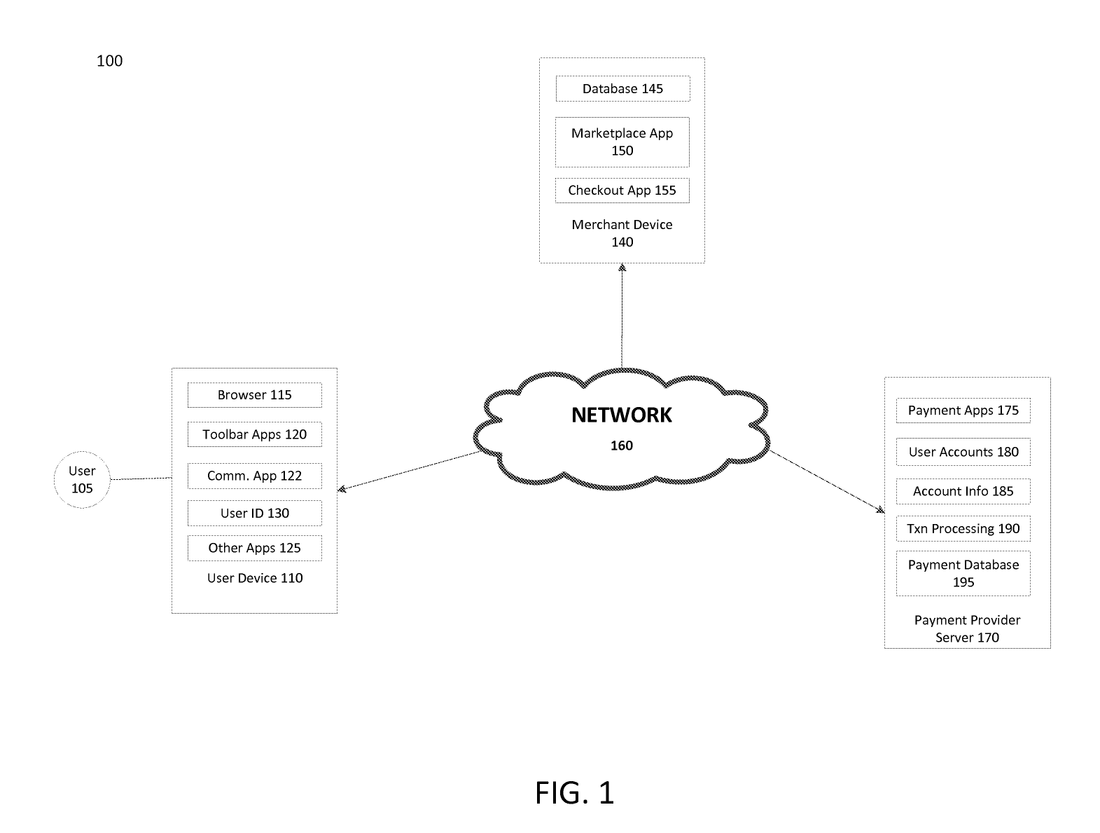

FIG. 1 is a block diagram of a networked system 100 suitable for implementing working capital for merchants according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one user device is shown, a plurality of user devices may utilize the payment service provider to make purchase at the merchant.

In an embodiment, user 105 may use user device 110 to interact with merchant device 140 which offers mobile devices and mobile service plans for sale. User 105 may apply for financing from the payment service provider for the purchase of a mobile device. For example, when user 105 selects a mobile device at the merchant's website, an option may be provided to user 105 during the checkout process to apply for financing for the cost of the mobile device from the payment service provider. If user 105 selects the option to apply financing from the payment service provider, user 105 may be re-directed to payment service provider's website for financing application. Payment provider server 170 may implement the financing application process for the cost of the mobile device.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (FDA), laptop computer, and/or other types of computing devices capable of transmitting and/or receiving data, such as an iPad™ from Apple™

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant server 140 may be maintained, for example, by a merchant or seller offering various products and/or services. In particular, the merchant may be a mobile service carrier offering various mobile devices and mobile services to customers. The mobile devices may include various wireless communication devices, such as cellular phones, wireless tablets, laptops, wireless mobile routers, or any devices that may be connected to the internet via wireless communication. The mobile services may include wireless communication service in CDMA, 3G, LTE, or any standard of wireless communication.

The merchant may have a physical point-of-sale (POS) store front. The merchant may have a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a saving account. Merchant server 140 may include a database 145 identifying available mobile device products (including digital goods) and/or mobile services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various mobile device products or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like. Checkout application 155 also may provide a link to apply financing from the payment service provider for the purchase of mobile devices. Thus, customers may apply for financing for the purchase of mobile devices during the checkout process.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

In some embodiments, payment provider server 170 may maintain a purchase/payment transaction database storing purchase or payment transaction history of various users. The purchase or payment transaction history may include payment transactions made, purchase transactions made, purchase volume, types of products or services purchased, time, and location of various purchase transactions processed through payment provider server 170. Payment provider server 170 may analyze the purchase/payment transaction history to determine and offer financing terms to a user for the purchase of a mobile device.

Payment provider server 170 also may maintain a financing database storing financing accounts of various customers who had financed the purchase of mobile devices through the payment service provider. The financing accounts may store financing information such as, a financed amount, repayment terms, projected payoff date, current balance, and the like. Thus, payment provider server 170 may monitor and keep track of various financing accounts and their repayment progress. Payment provider server 170 may maintain a credit/risk database storing credit/risk information of various merchants or customers. The credit/risk information may include sales or purchase history, payment history, transaction volume, credit scores, types of funding sources, and the like. The credit/risk information may be used to determine financing terms for the customers.

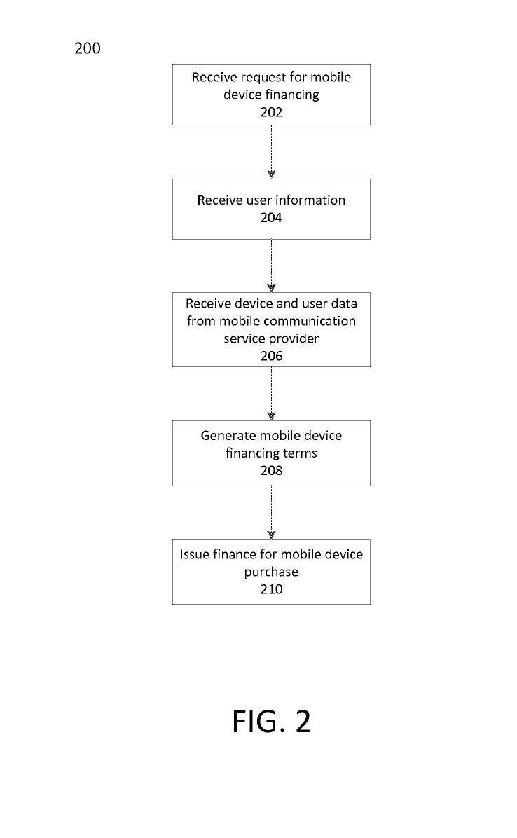

FIG. 2 is a flowchart illustrating a process 200 for implementing financing for a purchase of a mobile device according to an embodiment. At step 202, payment provider server 170 may receive a financing request for the purchase of a mobile device. The request may be initiated from user 105 at user device 110 or from a merchant at merchant device 140. For example, user 105 may visit a merchant's website or storefront to shop and purchase a mobile device along with a mobile service from the merchant. During a checkout process, either online or at the storefront, user 105 may have the option of financing the cost of the mobile device using the financing products offered at the payment service provider. User 105's financing request may be sent to payment provider server 170. In another example, user 105 may receive promotions, such as via email or text messages, from the merchant regarding new offers for mobile devices or mobile services. From the promotions, user 105 may be redirected to select and purchase mobile devices and/or mobile services from the merchant. Options for financing for the mobile device may be provided to user 105 during the checkout process.

At step 204, payment provider server 170 may receive user information from user 105. In particular, in response to receiving the financing request, payment provider server 170 may begin to request user information from user 105. For example, payment provider server 170 may inquire whether user 105 already has an account, such as a payment account, with payment service provider. If so, payment provider server 170 may request user 105 to log into user 105's payment account by entering, for example, login ID and/or password of user 105's payment account. Payment provider server 170 may authenticate user 105's entry and access user 105's payment account. User 105's information may be retrieved from user 105's payment account, including user 105's identity, geographic location, phone number, email address, social security number, age, birth date, gender, payment history, transaction history, purchase history, funding sources, such as credit card number, and/or bank number, cash flow, account balance history, and the like. The user information derived from user 105's payment account may be used to determine financing terms for user 105.

If user 105 does not have an account with the payment service provider, user 105 may be requested to open a payment account. In particular, payment provider server 170 may provide an interface for user 105 to enter various user information, such as name, login ID, password, location, phone number, email address, social security number, age, birth date, gender, funding sources, and the like. The information may be used to determine user 105's credit worthiness and financing terms for user 105. In an embodiment, user 105 may not currently have a payment account with the payment service provider, but used to have a payment account with payment service provider in the past. Payment service provider may use the information entered by user 105 and may find a past account of user 105. User 105 may be able to reactivate and update this old payment account. Further, payment service provider may retrieve user information from the old account, such as payment history, transaction history, purchase history, funding sources, such as credit card number, and/or bank number, cash flow, account balance history, and the like, to be used for determining credit worthiness.

At step 206, payment provider server 170 may receive device and user data from merchant device 140 of the mobile communication service provider. The device data may include the device type, model, price, specification, product description, and any information related to the device to be financed. Further, the device data also may include any compatible accessories, such as ear piece, charger, protective cover, and the like, of the device to be financed. In an embodiment, user 105 may wish to purchase one or more of the compatible accessories, which also may be financed along with the purchase of the mobile device.

User data may include user 105's mobile communication profile, such as call history, usage history, location history, service plan history, service payment history, device history, and any other information related to user 105's mobile service usage. The call history may include telephone calls made or received by user 105 using the mobile service. Usage history may include text massages, data usage, application usage, and the like. Location history may include geographic locations where user 105 has used the mobile service. Service plan history may include the type or service plans user 105 subscribed to currently or in the past. Service payment history may include the payment transactions made by user 105 for the mobile service. Device history may include devices that are used or had been used by user 105 to utilize the mobile service. The information may be used to determine a suitable mobile device and/or financing terms for user 105.

At step 208, payment service provider may generate mobile device financing terms for user 105. In particular, payment service provider may generate mobile device financing terms based on the user information derived from user 105's payment account at the payment service provider and the device and/or user data received from the mobile communication service provider. Payment provider server 170 may first determine whether user 105 is qualified for financing. The credit worthiness of user 105 may be determined based on user 105's payment history, cash flow history, transaction history, purchase history, account balance history, funding sources, and the like of user 105's payment account at the payment service provider. For example, a consistent positive cash flow at user 105's payment account may indicate that user 105 has good financial stability. On the other hand, if user 105 has persistent negative account balance, user 105 may have low financial stability.

The credit worthiness of user 105 also may be determined based on user 105's device and user data received from the mobile communication service provider. Thus, user information, such as call history, usage history, location history, service plan history, service payment history, device history, and any other information related to user 105's mobile service usage may be analyzed to determine user 105's credit worthiness. For example, if user 105 has consistently paid for the monthly service plan, user 105 may have good financial stability. If there is not sufficient information to make a determination, payment service provider may use a third-party credit rating entity, such as a credit bureau, to obtain credit related information, such as credit scores, of user 105. Thus, the payment service provider may consider user 105's payment account information at the payment service provider and user information from other entities to make a determination.

Based on the credit worthiness of user 105 and the price of the mobile device to be financed, payment provider server 170 may determine whether user 105 is qualified for the financing. A higher mobile device price may correspond to a higher credit worthiness requirement. Further, payment provider server 170 may take into account the incentives or discounts provided by the mobile communication service provider or the mobile device manufacturer that may lower the price of the mobile device.

If user 105 is qualified for financing the purchase of the mobile device, payment service provider may generate financial terms. In an embodiment, multiple financing options may be generated for user 105's selection. Each option may have different repayment terms and financing fees. For example, for a mobile device of $240.00, the different repayment options may be: $5 a month for 4 years, $10 a month for 2 years, or $20 a month for 1 year. Each repayment option may have different financing fee. Typically, a longer repayment period may correspond to a larger financing fee. For example, the financing fee for a 4 year repayment period is $50 while the financing fee for a 2 year repayment period is $25.

The financing terms also may be adjusted based on incentives or discounts provided by the mobile device manufacturer or the mobile communication service provider. For example, based on a manufacturer's discount, the financing terms may be adjusted to have a lower interest rate, longer grace period, and/or higher financing amount.

Different payment methods also may be presented to user 105. Payment methods may include credit card, bank account, check, and by payment account at the payment service provider. In particular, payment by the payment account may be preferred by the payment service provider. As such, the payment service provider may offer incentives for user 105 to pay the financing installments using user 105's the payment account. For example, a lower financing fee may be offered to user 105 if user 105 chooses to pay the financing installments using user 105's payment account. As such, payment service provider may automatically deduct the financing installment from user 105's payment account each month.

In an embodiment, incentives may be given to user 105 to pay both the installment for the mobile device and the monthly fee for the mobile service plan together using user 105's payment account. For example, one monthly fee may be calculated to include both the installment payment for the mobile device and the monthly fee for the mobile service. Payment service provider may automatically deduct the one monthly fee from user 105's payment account each month and take the monthly service fee from the one monthly fee and deposit the monthly service fee into the mobile communication service provider's account. Thus, user 105 only needs to make one payment each month for the mobile device and service.

An interface may be provided to present the various financing terms to user 105 and allow user 105 to choose a financing option. User 105 may choose a repayment option and a payment method from the options presented to user 105. After user 105's selections, payment provider server 170 may generate a financing agreement/contract based on the selected financing terms. The financing agreement/contract may describe the price and model of mobile device being financed, the agreed upon repayment arrangements, the payment methods, and other conditions and restrictions. The financing agreement/contract may be presented to user 105 for review and confirmation.

After user 105 reviews and agrees to the financing agreement/contract, payment service provider may issue the financing amount for the mobile device purchase at step 210. For example, the fund for the price of the mobile device may be deposited into the mobile communication service provider's account or an account of a mobile device merchant from which user 105 purchased the mobile device. After the mobile device is purchased by financing, payment provider server 170 may begin the repayment process.

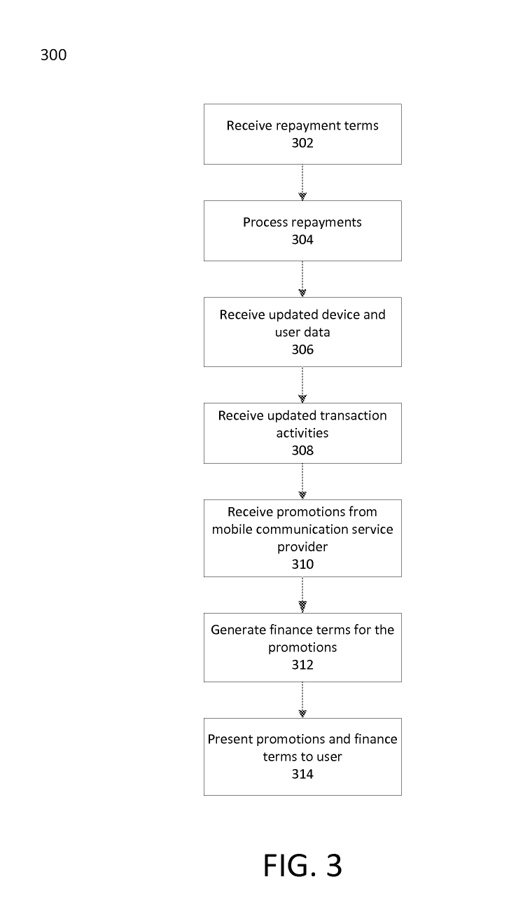

FIG. 3 is a flowchart illustrating a process 300 for implementing repayment and promotion for mobile device financing according to an embodiment. After user 105 purchased a mobile device by financing through the payment service provider, the payment service provider may implement process 300 to begin the repayment process. At step 302, payment provider server 170 may receive repayment terms. For example, based on the financing terms generated and agreed to by user 105 at step 208, payment provider server 170 may generate a repayment schedule.

At step 304, payment provider server 170 may begin to process repayments based on the repayment terms or schedule. For example, based on user 105's preference and setting, payment provider server 170 may automatically deduct or withdraw installment payments from user 105's payment account or other funding sources based on the repayment schedule. If user 105 does not set up the automatic payment function, reminders may be sent to user 105 to remind user 105 to make payments on time.

Payment provider server 170 may monitor user 105's repayment progress. For example, if a user is late or delinquent on a payment, payment provider server 170 may request that the mobile service provider remind user 105. If payments are consistently delinquent, payment provider server 170 may request mobile service provider to withhold mobile service from user 105. Payment provider server 170 also may generate and present payment progress summary to user 105. The payment progress summary may indicate the remaining balance, payment progress, projected pay off date, and the like.

At step 306, payment provider server 170 may continue to receive updated device and user data from the mobile communication service provider. In particular, the usage history, call history, digital footprint, geographic locations of user 105 when using the mobile device may be received from the mobile communication service provider. For example, the mobile device may have a payment application of the payment service provider installed thereon. As such, the mobile device may be linked to user 105's payment account and the device and user activities performed at the mobile device may be forwarded to the payment service provider. Thus, the payment provider server 170 may monitor the usage of mobile device to note any unusual activities. For example, if the mobile device becomes inactive for an extended period of time, the payment provider server 170 may send a notification to user 105 to ensure that the mobile device is still in good condition and not broken or stolen.

At step 308, payment provider server 170 may receive updated transaction activities. In particular, payment provider server 170 may continue to collect information regarding payment history, purchase history, transaction history, cash flow, account balance of user 105's payment account. Thus, payment provider server 170 may continue to monitor user 105's financial stability and credit worthiness. If payment provider server 170 detects any unusual trend of transactions at user 105's payment account, such as over draft or negative account balance, payment provider server 170 may take additional actions to ensure that user 105 is able to repay the rest of the financing balance. For example, if the payment service provider detects that user 105 may have difficulty making installment payments, the payment service provider may offer to buy back the mobile device or offer a lower priced mobile device to replace user 105's current device.

At step 310, payment provider server 170 may receive promotions from mobile communication service provider. For example, promotions for new mobile devices, new mobile service plans, incentives, and/or discounts may be received from the mobile communication service provider. Payment provider server 170 may determine whether user 105 may be interested in one or more of the received promotions, based on the updated device and user data and the updated transaction activities received at steps 306 and 308. For example, based on user 105's call or data usage, payment provider server 170 may determine that user 105 may be interested in upgrading to another service plan that provides greater speed, greater data usage limit, or greater call minutes. In another example, based on user 105's mobile device usage and user 105's purchase or browsing history, payment provider server 170 may determine that user 105 may be interested in upgrading to another mobile device that provides better camera or greater data storage.

At step 312, payment provider server 170 may generate financing terms for the upgrade promotions. In particular, payment provider server 170 may determine the additional cost or price that user 105 has to pay to get the mobile device upgrade or service plan upgrade. For example, the additional cost or price for the upgrade may be determined in terms of additional monthly payment or additional one-time payment. The additional cost may be the price of the new mobile device or new service plan minus the resale value of the original mobile device or the price of the original service plan.

Payment provider server 170 then may determine whether user 105 is able to afford the additional cost or price of upgrade. For example, payment provider server 170 may analyze user 105's repayment progress, the transaction history, payment history, cash flow history, and/or balance history of user 105's payment account to determine whether user 105 is able to make the additional payment for the upgrade. For example, if user 105 has a consistent account balance greater than the additional cost of upgrade and is making good repayment progress for the original mobile device, payment provider server 170 may determine that user 105 may be able to afford the additional cost of upgrade.

If user 105 can afford the additional cost of upgrade, payment provider server 170 may determine the financial terms for the upgrade. For example, a new monthly payment may be determined if user 105 is to upgrade to a new mobile device. Multiple options may be presented to user 105 to choose from for the upgrade. For example, user 105 may maintain the current repayment schedule, but may pay additional monthly amount for the upgrade. Thus, the same pay off date is maintained. In another example, the monthly payment is maintained while the repayment schedule is extended to add additional months to pay for the upgrade. In still another example, a new repayment schedule is created with a new monthly payment and a new pay off date.

At step 314, the promotions may be presented to user 105. For example, the promotions for new mobile devices or new mobile service plans may be presented to user 105 in an advertisement by email or text messages to entice user 105 to upgrade his or her mobile device or mobile service plan. If user 105 chooses to upgrade, payment provider server 170 may then present different financing options for user 105's selection. The financing options may include making additional monthly payment, extending repayment period, or both. In an embodiment, payment provider server 170 may select a financing option for user 105 based on user 105's financial ability determined based on the activities and status of user 105's payment account.

The above steps 306-314 may be implemented after user 105 has financed a mobile device and is in the repayment process. In another embodiment, the above steps 306-314 may be implemented before user 105 has financed a mobile from the payment service provider. Thus, promotions for mobile device or mobile service plans may be sent to account users of the payment service provider who have not financed mobile devices from the payment service provider to entice them to do as such.

Accordingly, by implanting the above processes 200 and 300, payment service provider may leverage user 105's payment account to determine financial stability and credit worthiness of user 105 for the purpose of financing a mobile device purchased by user 105. Further, payment service provider may monitor user the status and activities of user 105's payment account to determine mobile device or mobile service promotions that user 105 may be interested in and may be able to afford. Financing options for the promotions also may be determined and presented to user 105.

The following is an exemplary scenario in which the above processes 200 and 300 may be implemented:

Lisa has a PayPal account for sending and receiving payments. In particular, Lisa makes many online and in-store purchases using her PayPal account. Recently, Lisa is interested in buying a smart phone. Lisa visits a website of a mobile service provider. Lisa identifies a smart phone that she likes and decides to purchase the smart phone and subscribe to a mobile service plan offered by the mobile service provider. Lisa adds the smart phone and the mobile service plan to her virtual shopping cart at the mobile service provider's virtual store.

During the checkout process at the virtual store, Lisa is given the option of financing the cost of the mobile device through PayPal. The cost of the smart phone is $600. Lisa decides to finance the purchase of the smart phone. Lisa is requested to log into her PayPal account. PayPal then accesses the information of her PayPal account. In particular, PayPal analyzes her payment history, transaction history, cash flow history, balance history, and other activities associated with her payment account to determine whether Lisa qualifies for the financing of the smart phone.

Lisa consistently has good cash flow history and positive balance history. Thus, PayPal determines that Lisa has good credit worthiness and financial ability to qualify for financing the purchase of the $480 smart phone. PayPal then generates several options for financing the smart phone, such as a one-year payment plan with $42 monthly payment and a two-year payment plan with $23. The monthly payment includes financing fee. Lisa selects the two-year payment plan. PayPal then offers to lower the monthly payment to $22 if Lisa uses her PayPal payment account to automatically pay the monthly payment. Lisa agrees and accepts the payment arrangement to pay the monthly installment using her PayPal payment account.

PayPal then generates a mobile device financing agreement/contract describing the financing terms and other conditions and restrictions. Lisa agrees to the financing agreement/contract. PayPal then creates a financing account for Lisa including financing amount, repayment terms, and the like. PayPal then issues the fund to the mobile service provider for the purchase of the smart phone. Lisa then finishes the checkout process to purchase the phone and the mobile service plan from the mobile service provider.

Lisa then receives the smart phone in the mail and activates the smart phone. Lisa begins to use the smart phone for telephone calls, internet browsing, emails, taking photos, and various apps. PayPal begins to implement the repayment process for Lisa's phone and deducts the monthly payment from Lisa's payment account. PayPal receives smart phone usage information from the mobile service provider and notes that Lisa has been taking a lot of pictures using the smart phone, which has limited memory for storing these digital pictures.

PayPal recently receives promotion information from the mobile service provider advertising a new smart phone with greater memory storage. PayPal determines that Lisa may be interested in this device. PayPal also determines that Lisa is making good repayment progress and her payment account consistently has positive balance. Thus, PayPal sends the promotion for the new smart phone to Lisa. In particular, PayPal determines several options for financing for the phone upgrade. For example, Lisa may pay for the upgrade by paying $10 extra each month and maintain her current repayment schedule or pay the same monthly amount with the repayment schedule extended by a year. The promotion sent to Lisa may present the new smart phone to Lisa and emphasizing that the smart phone has more storage memory to store more pictures. Also, the promotion may state that the upgrade may be purchased “for only $10 extra monthly payment” or “maintain the same payment with extended repayment period.”

Lisa reviews the promotion and decides to purchase the new phone. Lisa is presented with the new financing terms for the upgrade. Lisa reviews and agrees to pay $10 extra to upgrade to the new smart phone. Instructions are also provided to Lisa on how to send in or trade in her original smartphone. Lisa then receives her new smart phone and enjoys the new smart phone with more memory storage for her pictures.

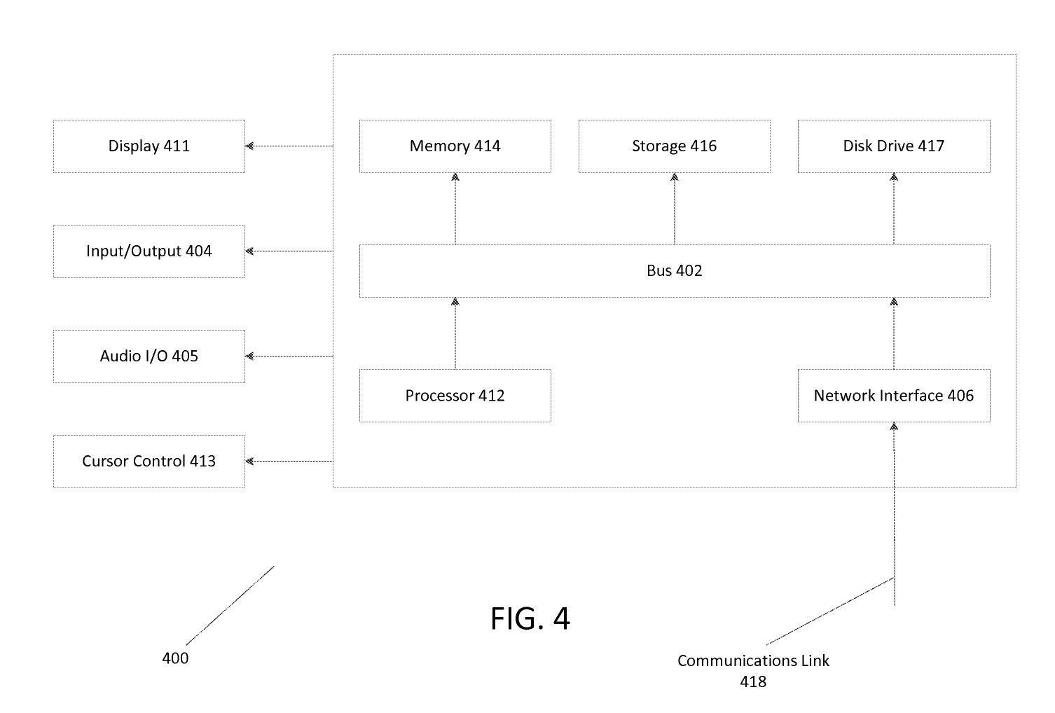

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or TP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing payment account information, including payment transactions processed through a payment service provider; and
one or more hardware processors coupled to the memory and operable to read the instructions from the memory to perform the steps of:
receive a request to finance a purchase of a mobile device by a user;
determine financing terms for the purchase of the mobile device based on information derived from the user's payment account at the payment service provider;
present the financing terms to the user; and
provide financing for the purchase of the mobile device.

2. The system of claim 1, wherein the information derived from the user's payment account comprise one or more of payment history, purchase history, transaction history, cash flow history, balance history, and funding sources.

3. The system of claim 1, wherein the financing terms are further based on an incentive provided by a mobile carrier or a seller of the mobile device.

4. The system of claim 1, wherein multiple options of financing terms with various monthly payments and repayment schedules are generated and presented to the user.

5. The system of claim 1, wherein the one or more hardware processors are further adapted to:
generate a repayment schedule based on the financing terms; and
automatically deduct repayments from the user's payment account based on the repayment schedule.

6. The system of claim 1, wherein the one or more hardware processors are further adapted to:
receive promotions for upgrading the mobile device;
select an upgrade mobile device from the promotions based on user's mobile service usage;
determine financing terms for the upgrade mobile device based on the information derived from the user's payment account at the payment service provider; and
present the promotions for the upgrade mobile device along with the financing terms for the upgrade mobile device to the user.

7. The system of claim 5, wherein the financing terms for the upgrade mobile device comprise one or both of an extra monthly payment and an extended repayment schedule.

8. A non-transitory machine-readable medium comprising a plurality of machine-readable instructions which when executed by one or more processors of a server are adapted to cause the server to perform a method comprising:
receiving a request to finance a purchase of a mobile device by a user;
determining financing terms for the purchase of the mobile device based on information derived from a payment account of the user at a payment service provider;
presenting the financing terms to the user; and
providing financing for the purchase of the mobile device.

9. The non-transitory machine-readable medium of claim 8, wherein the information derived from the user's payment account comprise one or more of payment history, purchase history, transaction history, cash flow history, balance history, and funding sources.

10. The non-transitory machine-readable medium of claim 8, wherein the financing terms are further based on an incentive provided by a mobile carrier or a seller of the mobile device.

11. The non-transitory machine-readable medium of claim 8, wherein multiple options of financing terms with various monthly payments and repayment schedules are generated and presented to the user.

12. The non-transitory machine-readable medium of claim 8, wherein the method further comprising:
generating a repayment schedule based on the financing terms; and
automatically deducting repayments from the user's payment account based on the repayment schedule.

13. The non-transitory machine-readable medium of claim 8, wherein the method further comprising:
receiving promotions for upgrading the mobile device;
selecting an upgrade mobile device from the promotions based on user's mobile service usage;
determining financing terms for the upgrade mobile device based on the information derived from the user's payment account at the payment service provider; and
presenting the promotions for the upgrade mobile device along with the financing terms for the upgrade mobile device to the user.

14. The non-transitory machine-readable medium of claim 13, wherein the financing terms for the upgrade mobile device comprise one or both of an extra monthly payment and an extended repayment schedule.

15. A method comprising:
receiving, by a hardware processor of a payment service provider, a request to finance a purchase of a mobile device by a user;
determining financing terms for the purchase of the mobile device based on information derived from a payment account of the user at the payment service provider;
presenting the financing terms to the user; and
providing financing for the purchase of the mobile device.

16. The method of claim 15, wherein the information derived from the user's payment account comprise one or more of payment history, purchase history, transaction history, cash flow history, balance history, and funding sources.

17. The method of claim 15, wherein the financing terms are further based on an incentive provided by a mobile carrier or a seller of the mobile device.

18. The method of claim 15, wherein multiple options of financing terms with various monthly payments and repayment schedules are generated and presented to the user.

19. The method of claim 15 further comprising:
generating a repayment schedule based on the financing terms; and
automatically deducting repayments from the user's payment account based on the repayment schedule.

20. The method of claim 15 further comprising:
receiving promotions for upgrading the mobile device;
selecting an upgrade mobile device from the promotions based on user's mobile service usage;
determining financing terms for the upgrade mobile device based on the information derived from the user's payment account at the payment service provider; and
presenting the promotions for the upgrade mobile device along with the financing terms for the upgrade mobile device to the user.

21. The method of claim 20, wherein the financing terms for the upgrade mobile device comprise one or both of an extra monthly payment and an extended repayment schedule.
